(19) United States
(12) Patent Application Publication
(10) Pub. No.: US 2026/0083112 A1
(43) Pub. Date: Mar. 26, 2026

(54) ARTICULATION ROD RACK ARRANGEMENT AND ACTUATOR ARRANGEMENT

(71) Applicant: Patrick Industries, Inc., Elkhart, IN (US)

(72) Inventors: Scott Lee Danforth, Bradenton, FL (US); Adam Sheppard, Greensboro, NC (US)

(21) Appl. No.: 19/314,567

(22) Filed: Aug. 29, 2025

Related U.S. Application Data
(63) Continuation-in-part of application No. 19/312,577, filed on Aug. 28, 2025.
(60) Provisional application No. 63/698,742, filed on Sep. 25, 2024.

(51) Int. Cl. A01K 97/10; B63B 27/14

(52) U.S. Cl. CPC A01K 97/10; B63B 27/14

(57) ABSTRACT

An articulating rod rack arrangement for a marine vehicle including a first rotary actuator coupled to a marine surface, the first rotary actuator including a housing coupled to the marine surface, a motor including a motor shaft, a worm gear assembly operably coupled to the motor shaft, a first output plate rotatably coupled to the housing and operably coupled to the worm gear assembly, and a second output plate rotatably coupled to the housing and operably coupled to the worm gear assembly. A rod rack is operably coupled to one of the first output plate and the second output plate, wherein the rod rack is rotatable between a raised position and a lowered position and includes a crossbar and one or more rod holders coupled to the crossbar.

### CROSS-REFERENCE TO RELATED APPLICATIONS

This application is a continuation-in-part of U.S. patent application Ser. No. 19/312,577, filed Aug. 28, 2025, entitled “ARTICULATING MARINE STEP ARRANGEMENT AND ACTUATOR ARRANGEMENT,” which claims benefit to U.S. Provisional Patent Application No. 63/698,742, filed Sep. 25, 2024, entitled “ARTICULATING MARINE STEP ARRANGEMENT AND ACTUATOR ARRANGEMENT,” the entire disclosure of which is incorporated herein by reference.

### BACKGROUND OF THE DISCLOSURE

The present disclosure generally relates to a marine rod rack arrangement and in particular to an articulating rod rack arrangement where a rod rack is actuated by a rotary actuator for multiple uses in the marine market, including an articulating step application, an articulating rod rack application, and the like.

### SUMMARY OF THE DISCLOSURE

One example as shown and described herein includes an articulating rod rack arrangement for a marine vehicle including a first rotary actuator configured to be directly coupled to a marine surface, the first rotary actuator including a housing, a motor disposed within the housing and having a motor shaft, a worm gear assembly operably coupled to the motor shaft, and an output plate operably coupled to the worm gear assembly and rotatably coupled to the housing. A first arm has a first end and a second end, wherein the first end is coupled to the output plate, and a crossbar is coupled to the second end of the first arm such that the crossbar is spaced from the first rotary actuator, the crossbar supporting one or more rod holders, wherein the first rotary actuator is configured to rotate the first arm and the crossbar such that the crossbar is rotatable relative to the housing of the first rotary actuator.

Another example as shown and described herein may further or alternatively include an articulating rod rack arrangement including a first rotary actuator and a second rotary actuator laterally spaced from the first rotary actuator, each of the first rotary actuator and the second rotary actuator being coupled to a marine surface and including a water-tight sealed housing coupled to the marine surface and defining a port, a motor including a motor shaft configured to rotate about an input axis, a worm gear assembly operably coupled to the motor shaft, and an output plate rotatably coupled to the housing, wherein the output plate is configured to rotate about an output axis. A first arm and a second arm each has a first end coupled to one of the output plate of the first rotary actuator and the output plate of the second rotary actuator and a second end extended from one of the first rotary actuator and the second rotary actuator, and a crossbar is coupled to the second end of each of the first arm and the second arm and rotatable relative to the marine surface between a raised position and a lowered position, wherein the crossbar is in a spaced relationship with each of the first rotary actuator and the second rotary actuator in the raised position and the lowered position. One or more rod holders are coupled to the crossbar.

Yet another example as shown and described herein may further or alternatively include an articulating rod rack arrangement for a marine vehicle including a first rotary actuator coupled to a marine surface, the first rotary actuator including a housing coupled to the marine surface, a motor including a motor shaft configured to rotate about an input axis, a worm gear assembly operably coupled to the motor shaft, a first output plate rotatably coupled to the housing and operably coupled to the worm gear assembly, and a second output plate rotatably coupled to the housing and operably coupled to the worm gear assembly, wherein the first output plate and the second output plate are rotatable about an output axis. A rod rack is operably coupled to one of the first output plate and the second output plate, wherein the rod rack is rotatable between a raised position and a lowered position and includes a crossbar and one or more rod holders coupled to the crossbar.

### BRIEF DESCRIPTION OF THE DRAWINGS

FIG. 1 is a side perspective view of a rotary actuator for multiple marine applications;

FIG. 2 is a side perspective view of a drive train of the rotary actuator;

FIG. 3 is a cross-sectional, side perspective view of the rotary actuator;

FIG. 4 is a cross-sectional perspective end view of the rotary actuator;

FIG. 5 is a side perspective view of a housing of the rotary actuator where the housing is partially hidden to show a wheel gear and a clutch of the drive train of the rotary actuator;

FIG. 6 is a perspective view of the rotary actuator where the housing is hidden to show components of the drive train of the rotary actuator;

FIG. 7 is an exploded perspective view of the rotary actuator;

FIG. 8 is a top perspective view of the rotary actuator, wherein the motor cover is partially hidden;

FIG. 9 is a perspective view of the housing of the rotary actuator;

FIG. 10 is a side perspective view of the rotary actuator where the housing is hidden to show the worm gear and the wheel gear, where the wheel gear is partially hidden to show a pair of clutches of the drive train of the rotary actuator;

FIG. 11 is a side perspective view of an articulating step arrangement mounted under a gunwale of a marine vehicle with a step in a retracted position, the articulating step arrangement including two rotary actuators;

FIG. 12 is a side perspective view of the articulating step arrangement mounted under the gunwale of the marine vehicle with the step in an extended position, the articulating step arrangement including two rotary actuators;

FIG. 13 is a side perspective view of the articulating step arrangement mounted under the gunwale of the marine vehicle with the step in a retracted position, the articulating step arrangement including one rotary actuator;

FIG. 14 is a line graph showing the relationship between an angular velocity of a one-start worm gear assembly and a torque output of the one-start worm gear assembly, where the rotary actuator has a 50:1 gear ratio;

FIG. 15 is a side perspective view of the rotary actuator integrated within the articulating step arrangement mounted under the gunwale of the marine vehicle, where the rotary actuator includes a manual drive port;

FIG. 16 is a side perspective view of an articulating rod rack arrangement including a rod rack and two rotary actuators, where the rod rack is shown in a fully lowered position and a fully raised position;

FIG. 17 is a detailed perspective view of the rod rack of the articulating rod rack arrangement;

FIG. 18 is a rear side perspective view of the articulating rod rack arrangement including the rod rack and two rotary actuators;

FIG. 19 is a detailed rear side perspective view of a connection between the rod rack and

one rotary actuator of the articulating rod rack arrangement;

FIG. 20 is a detailed rear side perspective view of a connection between a crossbar of the rod rack and one rotary actuator of the articulating rod rack arrangement;

FIG. 21 is a side perspective view of the articulating rod rack arrangement including the rod rack and two rotary actuators coupled to a top panel of a marine vehicle, where the rod rack is shown in a fully lowered position and a fully raised position; and

FIG. 22 is a side perspective view of the articulating rod rack arrangement including the rod rack and two rotary actuators coupled to the top panel of the marine vehicle, where the rod rack is shown in a fully lowered position and a fully raised position.

### DETAILED DESCRIPTION OF THE PREFERRED EMBODIMENTS

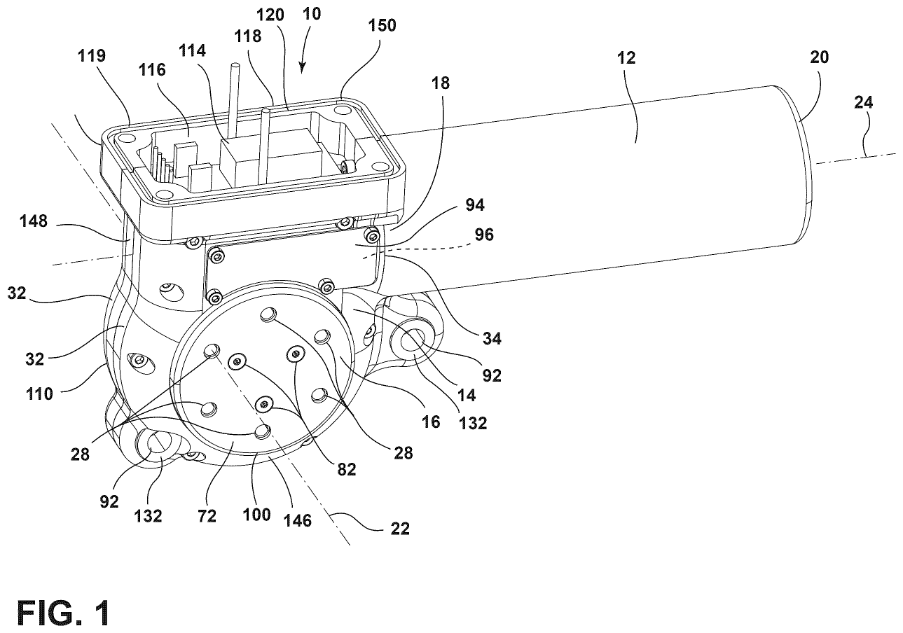

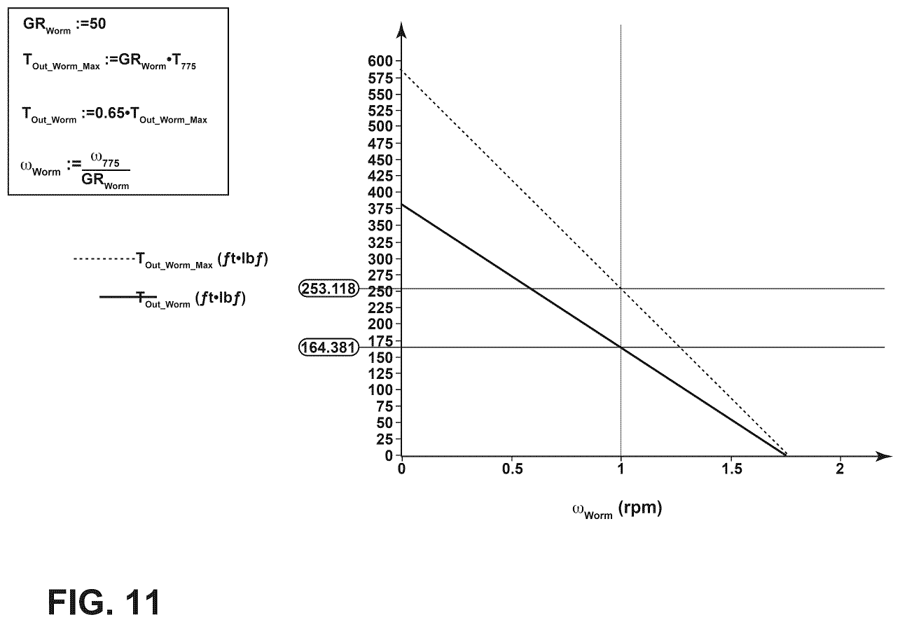

For purposes of description herein, the terms “upper,” “lower,” “right,” “left,” “rear,” “front,” “vertical,” “horizontal,” and derivatives thereof shall relate to the invention as oriented in FIGS. 1 and 11. Unless stated otherwise, the term “front” shall refer to the surface of the element closer to an intended viewer of the mirror element, and the term “rear” shall refer to the surface of the element further from the intended viewer of the mirror element. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Referring now to FIG. 1, reference numeral 10 generally designates a rotary actuator for use within an articulating step arrangement 158 (FIG. 11) and/or an articulating rod rack arrangement 230 as described below. The rotary actuator 10 generally includes a motor cover 12 and a housing 14. Together, the motor cover 12 and the housing 14 form a housing assembly. Connected to the housing 14 is a clutch plate 16 configured to rotate relative to the housing 14. The motor cover 12 has an attachment end 18 coupled to the housing 14 and a free end 20 protruded from the housing 14. The clutch plate 16 is rotatable about an output axis 22 that is substantially perpendicular to an input axis 24 of a motor 26, the motor 26 being disposed within the motor cover 12. The output axis 22 is additionally offset from the input axis 24. The clutch plate 16 has several attachment points 28 that may receive a variety of components, such as marine step linkages, Bimini top components, rod rack arms, bulwark components, and other components as described below. Generally, the clutch plate 16 may freely rotate between zero and 360 or more degrees. In some configurations, rotation of the clutch plate 16 may be manually or electronically limited to a narrower rotational range.

The coupling of the housing 14 and the attachment end 18 of the motor cover 12 creates a sealed connection provided by a sealant to retain lubrication in the housing 14 and/or to prevent water intrusion into the rotary actuator 10. The attachment end 18 of the motor cover 12 may define threads configured to secure to the housing 14. The housing 14 generally comprises two housing halves 32, which are also coupled together using a sealant to form a sealed connection. When the housing halves 32 are coupled together, the housing 14 defines an attachment port 34 that receives the attachment end 18 of the motor cover 12. The sealants used in the construction of the rotary actuator 10 described herein may include, but are not limited to, an elastomeric seal, an O-ring, and/or a liquid sealant such as Aviation Form-A-Gasket No. 3 Sealant, as available from Permatex®.

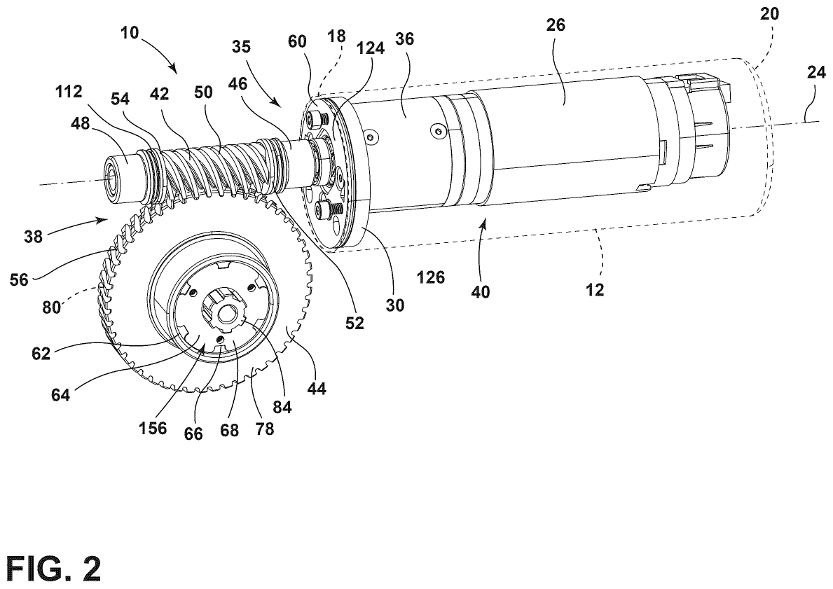

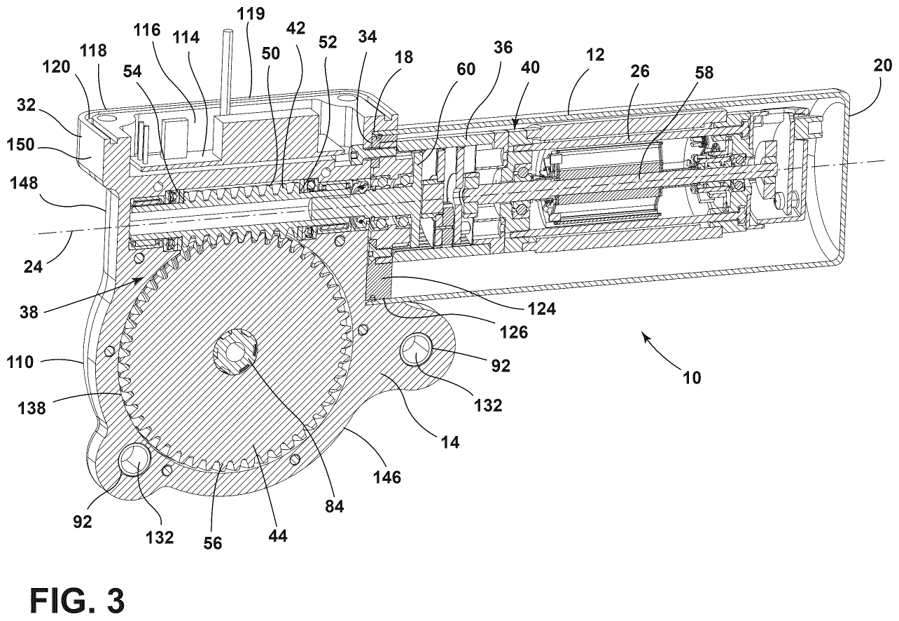

Referring to FIGS. 2 and 3, the rotary actuator 10 includes a drive train 35. To maximize the available torque of the rotary actuator 10, a gear reduction assembly 36 is coupled to the motor 26, and the gear reduction assembly 36 is connected to a worm gear assembly 38. The motor 26 and the gear reduction assembly 36 may be provided as a single, integrated unit or as multiple separate components. As illustrated, the motor 26 and the gear reduction assembly 36 are combined into a single, integrated unit, forming a gearmotor 40.

The gear reduction assembly 36 may include a variety of different gear ratios. As a result, the power output of the drive train 35 is modifiable. Additionally, the angular velocity of the drive train 35 can be varied in response to an alteration of the gear ratio of the gear reduction assembly 36. The gear reduction assembly 36 may be a two-stage planetary gear assembly, a three-stage planetary gear assembly, or a further-staged planetary gear assembly in some configurations and may be based on the use case of the rotary actuator 10. For example, a gear reduction ratio for the articulating step arrangement 158 may be 12.5:1; a gear reduction ratio for the articulating rod rack arrangement 230 may be 25:1; and a gear reduction ratio for powered door or bulwark arrangements may be 50:1.

The worm gear assembly 38 includes a worm gear 42 and a wheel gear 44. The worm gear 42 is situated between two flanged bearings 46, 48, has one or more helical teeth 50, and generally has between one and six starts. The worm gear 42 also has a first worm end 52 and a second worm end 54. The wheel gear 44 has slanted teeth 56 configured to receive the helical teeth 50 of the worm gear 42 as the worm gear 42 rotates. The rotation of the worm gear 42 occurs along the input axis 24, which runs along the worm gear 42 and through the flanged bearings 46, 48. The input axis 24 is substantially coaxial to the axis of rotation of a motor shaft 58 of the motor 26. According to some aspects, the first worm end 52 of the worm gear 42 is either directly connected to the motor shaft 58 of the motor 26 or coupled to the motor shaft 58 via an adapter piece 60. Notably, the coaxial relationship between the input axis 24 and the axis of rotation of the motor shaft 58 is not required for the rotary actuator 10.

The wheel gear 44 may have fifty or more slanted teeth 56, which may inhibit or prevent back driving of the drive train 35 of the rotary actuator 10. As illustrated in FIG. 2, the wheel gear 44 has fifty slanted teeth 56. The wheel gear 44 also defines an opening 62 along the output axis 22 about which the wheel gear 44 rotates. A clutch 64 is coupled to the wheel gear 44 and is disposed within the opening 62 such that the clutch 64 rotates coaxially with the wheel gear 44. The opening 62 of the wheel gear 44 has an engagement mechanism 66 to couple the wheel gear 44 and the clutch 64, which may include internal fingers, hex grooves, double hex grooves, or spline grooves. The clutch 64 is further configured to engage with the clutch plate 16 such that the clutch plate 16 is rotatably coupled to the housing 14.

With reference to FIGS. 2 and 3, the wheel gear 44 is encapsulated with the housing 14 such that the wheel gear 44 does not intersect the input axis 24. The motor 26 sits within the motor cover 12. The motor 26 is connected to the gear reduction assembly 36 that is in turn connected to the adapter piece 60. The adapter piece 60 is connected to the worm gear 42 such that rotation of the worm gear 42 is driven by the actuation of the motor 26. When the motor cover 12 is coupled to the housing 14, the gearmotor 40 is disposed within the motor cover 12, and the adapter piece 60 is partially disposed in both the motor cover 12 and the housing 14. It is contemplated that the adapter piece 60 may be fully disposed in either the housing 14 or the motor cover 12. In some constructions, the gear reduction assembly 36 or the worm gear 42 may be partially encapsulated in the motor cover 12 and the housing 14.

Referring now to FIGS. 3-5, the rotary actuator 10 is shown having multiple clutches 64 and multiple clutch plates 16. Particularly, the rotary actuator 10 includes a first clutch 68, a second clutch 70, a first clutch plate 72, and a second clutch plate 74. The pair of clutches 68, 70 are disposed within the opening 62 of the wheel gear 44 on opposing sides of a rotation plane 76 of the wheel gear 44. The pair of clutch plates 72, 74 are located outward from the rotation plane 76 relative to the pair of clutches 68, 70. The first clutch 68 and the first clutch plate 72 are disposed on a first side 78 of the wheel gear 44, while the second clutch 70 and the second clutch plate 74 are disposed on a second side 80 of the wheel gear 44. The first clutch plate 72 is coupled to the first clutch 68, and the second clutch plate 74 is coupled to the second clutch 70. The first clutch 68 is configured to pressingly engage with and disengage from the first clutch plate 72 in response to the rotation of the wheel gear 44 and torque loads applied to the first clutch plate 72. Similarly, the second clutch 70 is configured to engage with and disengage from the second clutch plate 74 in response to the rotation of the wheel gear 44 and torque loads applied to the second clutch plate 74.

According to some aspects, the pair of clutch plates 72, 74 are not directly coupled to the wheel gear 44. The pair of clutches 68, 70 receive an output shaft 82 and are secured on the output shaft 82 by a pair of opposing securement pins 84 coupled to the output shaft 82. The securement pins 84 may be portions of a three-millimeter alignment pin. Notably, the exact dimensions of the securement pins 84 may vary. The output shaft 82 may define a cylindrical external profile or alternatively may include one or more outward-extending teeth configured to interlock with the pair of clutches 68, 70.

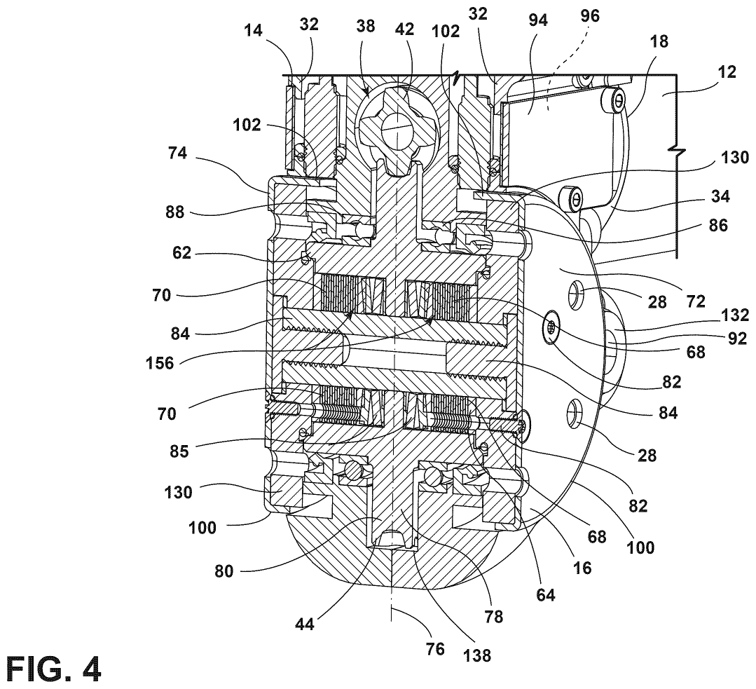

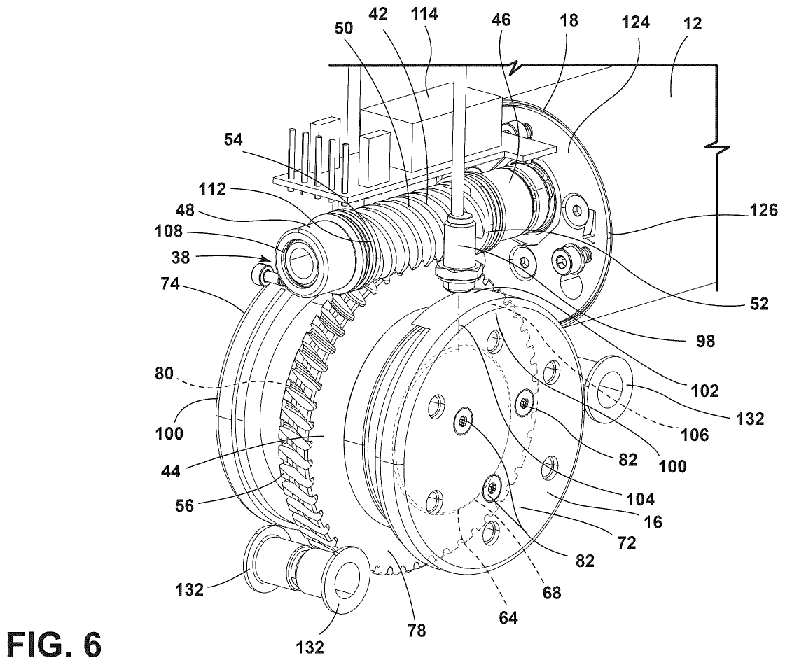

Referring to FIGS. 4-6, the pair of clutches 68, 70 are configured to engage the pair of clutch plates 72, 74, respectively. When the motor 26 of the rotary actuator 10 is activated, the motor shaft 58 (FIG. 3) drives the worm gear assembly 38. In response, the clutches 68, 70 rotate with the wheel gear 44 and respectively engage the clutch plates 72, 74, thereby driving the clutch plates 72, 74. In some instances, the clutches 68, 70 are clutch discs or friction discs, where each of the clutches 68, 70 incorporates one or more Belleville washers 85 to bias the clutches 68, 70 toward the clutch plates 72, 74, respectively. Notably, the illustrated clutches 68, 70 are not limited to such configurations. For example, the exclusion of the clutches 68, 70 in the drive train 35 may be preferred in some instances.

The wheel gear 44 is rotatably coupled to the housing 14 via annular bearings. Particularly, a first annular bearing 86 is disposed on the first side 78 of the wheel gear 44 between the wheel gear 44 and the housing 14, and a second annular bearing 88 is disposed on the second side 80 of the wheel gear 44 between the wheel gear 44 and the housing 14. The annular bearings 86, 88 are respectively separated from the clutch plates 72, 74 by a pair of annular gaskets 90, one of the pair of annular gaskets 90 being disposed between the first annular bearing 86 and the first clutch plate 72 and one of the pair of annular gaskets 90 being disposed between the second annular bearing 88 and the second clutch plate 74. The pair of annular gaskets 90 provide a water-tight seal between the housing 14 and the clutch plates 72, 74 such that the connection between the clutch plates 72, 74 and the housing 14 has an ingress protection rating of at least IP66. In some configurations, the connection between the housing 14 and clutch plates 72, 74 may have an ingress protection rating of IP67 or IP68.

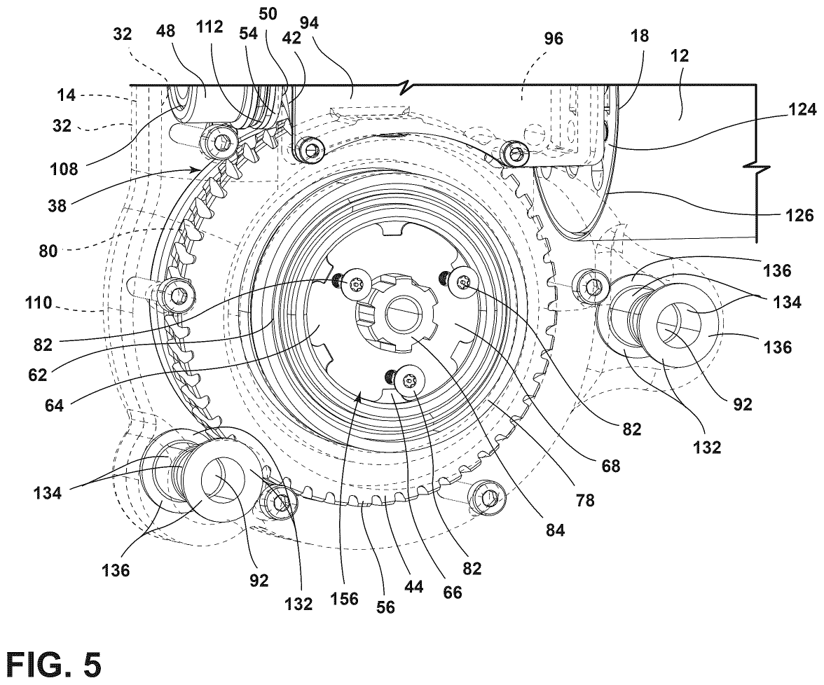

The housing halves 32 (FIG. 5) of the housing 14 are generally coupled together to encapsulate, among other things, the worm gear assembly 38 and the first and second clutches 68, 70. The housing halves 32 are connected using fasteners and/or a sealant. The housing halves 32 are further configured to couple to the motor cover 12 and the first and second clutch plates 72, 74. One or more ports 92 are also optionally defined by the housing 14, which may be utilized for the attachment of mechanical components in certain applications.

With reference to FIGS. 5-7, a pair of side plates 94 are disposed on the housing 14 above the first clutch plate 72 and the second clutch plate 74, respectively. Each of the pair of side plates 94 covers one of a pair of side cavities 96 defined by the housing 14, where the pair of side cavities 96 are situated on opposing sides of the rotation plane 76. A sensor 98 is disposed in each of the pair of side cavities 96. The pair of side plates 94 are coupled to the housing 14 via fasteners and/or a sealant. For example, a screw, such as a hex screw, may be used to couple the housing halves 32 to each other and/or the side plates 94 to the housing 14. If a liquid sealant is used, the liquid sealant is disposed along points of contact between the housing halves 32 and/or between the side plate 94 and the housing 14, creating a sealed connection having an ingress protection rating of at least IP66. In some instances, the sealed connection between the housing halves 32 and/or between the pair of side plates 94 and the housing 14 may have an ingress protection rating of IP67 or IP68. The attachment end 18 of the motor cover 12 may define threads that are received by the housing 14. Here, fasteners and/or a sealant may be used to create a sealed connection between the motor cover 12 and the housing 14 with an ingress protection rating of at least IP66. In some instances, the sealed connection between the motor cover 12 and the housing 14 may have an ingress protection rating of IP67 or IP68.

Each of the pair of sensors 98 is disposed within one of the pair of side cavities 96 of the housing 14 to detect a rotational position of one of the first clutch plate 72 and the second clutch plate 74. Each of the first clutch plate 72 and the second clutch plate 74 has a perimeter 100 that includes a flange 102 extending inward toward the housing 14. Here, the flange 102 extends into a detection path 104 of one of the pair of sensors 98 when the flange 102 is in a base position. As the first clutch plate 72 and the second clutch plate 74 rotate, each of the flanges 102 thereof is configured to move into and out of the detection path 104 of one of the pair of sensors 98. Each of the first clutch plate 72 and the second clutch plate 74 is rotatable between a stowed position of zero degrees and a deployed position that can be an angular offset relative to the stowed position of one to 360 or more degrees. In an articulating step or powered seat application, for example, one angular offset between the stowed position and the deployed position may be 30 to 135 degrees. In other applications, such as a lead/ball screw application or a belt drive application for powered doors, the angular offset may be 360 or more degrees. In some instances, there may be more than one flange 102 included on the perimeter 100 of one or both of the first clutch plate 72 and the second clutch plate 74. The direction of the detection path 104 is not limited to a vertical direction. In some instances, the rotary actuator 10 may include a single sensor 98 disposed in one of the pair of side cavities 96 proximate one of the first side 78 of the wheel gear 44 and the second side 80 of the wheel gear 44. Additionally or alternatively, the rotary actuator 10 may include a single side cavity 96 and a single side plate 94.

Referring still to FIGS. 5-7, the flange 102 of each of the first clutch plate 72 and the second clutch plate 74 may include a flag 106 signaling a home position. Here, the flag 106 may include an IP66-rated switch, an IP67-rated switch, or an IP68-rated switch, and said switch may be a magnetic reed switch or an inductive proximity switch, for example. The flag 106 may be machined into the flange 102 of each of the first clutch plate 72 and the second clutch plate 74 or may be fixed to the flange 102 of each of the first clutch plate 72 and the second clutch plate 74. The rotary actuator 10 may include end-of-stroke signaling and/or a current limiting device to prevent damage at the end of an operation of the rotary actuator 10. Alternatively, the rotary actuator 10 may rely solely on the pair of clutches 68, 70 for torque limiting. In applications including end-of-stroke signaling, the rotary actuator 10 may acquire one or more end-of-stroke signals from one or both of the pair of sensors 98.

The flanged bearings 46, 48 are disposed within the housing 14 and are axially aligned with the input axis 24 of the motor 26 and the worm gear 42, the flanged bearings 46, 48 each having a thrust bearing surface 108. Bearings of a plain bearing type or a Delrin bearing type may be used for the flanged bearings 46, 48. An inner flanged bearing 46 is disposed at the first worm end 52 proximate the motor cover 12, and an outer flanged bearing 48 is disposed at the second worm end 54 proximate an end 110 of the housing 14 opposite the motor cover 12. The inner and outer flanged bearings 46, 48 are further configured to receive the worm gear 42, enabling rotation of the worm gear 42 with respect to the housing 14, the worm gear 42 rotating about the input axis 24. To prevent wear, a hardened washer 112 may be disposed between the outer flanged bearing 48 and the helical teeth 50 of the worm gear 42 and receive the worm gear 42. The flanged bearings 46, 48 further retain the worm gear 42 at a position proximate to the wheel gear 44 such that the slanted teeth 56 of the wheel gear 44 receive the helical teeth 50 of the worm gear 42. Notably, additional bearings may be respectively disposed between the inner flanged bearing 46 and the worm gear 42 and between the outer flanged bearing 48 and the worm gear 42. Alternatively, the inner flanged bearing 46 and the outer flanged bearing 48 may be respectively substituted with a pair of ball bearings or a pair of another type of bearings in some instances.

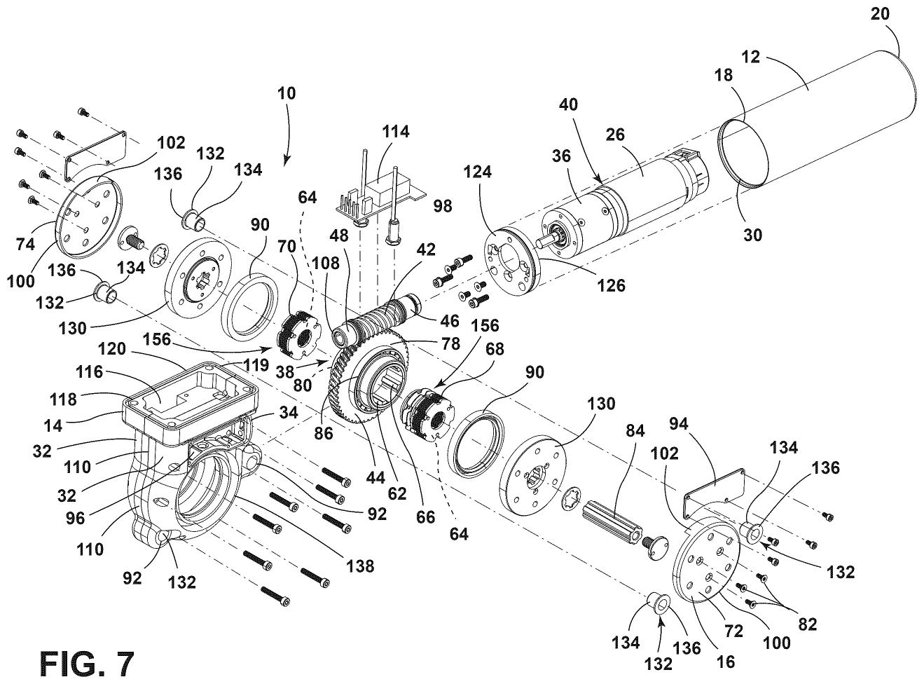

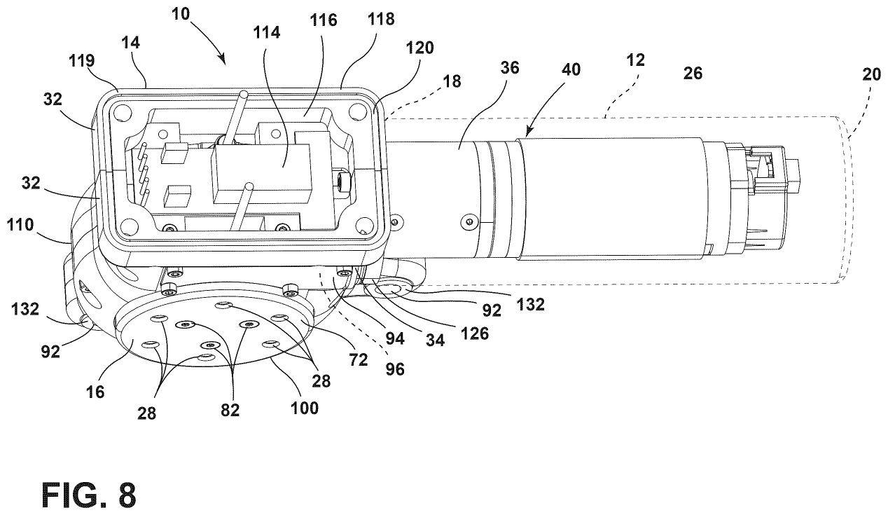

Referring now to FIGS. 7 and 8, the rotary actuator 10 is configured to operate on common direct current system voltages and may also communicate with digital switching systems pursuant to the National Marine Electronics Association (NMEA) 2000 standard. The articulation and control of the actuation of the rotary actuator 10 may be controlled by a switch, a controller area network controller, and/or a multifunctional display such as a touchscreen display or a display with discrete buttons. In applications utilizing more than one rotary actuator 10, operation of the rotary actuators 10 may be tied together to perform common functions, achieve motor synchronization, and allow simultaneous monitoring. To achieve methods of communication, articulation, and control, the rotary actuator 10 includes a control board 114 disposed within a control compartment 116 defined by the housing 14. The control board 114 disposed in the control compartment 116 of the housing 14 may enable one or more of these desired methods, the combination of which may vary between applications. Utilizing internal sensors and/or controls, the control board 114 may be in communication with a control module and/or other actuators, such as another rotary actuator 10, to perform functions including sequencing, position limiting, and/or force limiting.

The control compartment 116 may further house wiring for electronic arrangements such as the motor 26, an encoder, and/or one or more end-of-stroke switches. The control compartment 116 is configured to couple to an external surface, creating a water-tight seal between the control compartment 116 and an environment external to the rotary actuator 10. Particularly, the housing 14 includes a peripheral sidewall 118 surrounding the control compartment 116, the peripheral sidewall 118 having a terminal end 119. A groove 120 runs along the terminal end 119 of the peripheral sidewall 118. The groove 120 is configured to receive a gasket, such as an O-ring, to assist with creating a sealed connection between the housing 14 at the terminal end 119 of the peripheral sidewall 118 and an external surface, providing the control compartment 116 with an ingress protection rating of IP66, IP67, or IP68.

With further reference to FIGS. 7 and 8, the motor 26 is disposed within the motor cover 12. The motor 26 is coupled to the gear reduction assembly 36, and the gear reduction assembly 36 is in turn coupled to the adapter piece 60. The adapter piece 60 is coupled to the worm gear 42 of the worm gear assembly 38. The gear reduction assembly 36 is coupled to a motor adaptor 124. The motor adaptor 124 is configured to connect to a variety of motors and gear reduction assemblies via fasteners, such as studs or threaded cap screw fasteners, for example. An outer diameter 126 of the motor adaptor 124 may further define threads configured to couple to the threads of the motor cover 12. In such constructions, the motor adaptor 124 is in turn coupled to the housing 14. A sealant may also be used to create a sealed connection between the motor adaptor 124 and the motor cover 12 and/or a sealed connection between the motor adaptor 124 and the housing 14. If an O-ring, seal, or gasket is used to seal the connection of the motor adaptor 124 and the motor cover 12, the motor cover 12 may further define a seal groove to receive the O-ring, seal, or gasket.

According to some aspects, the rotary actuator 10 may include a pair of intermediate plates 130, where one of the pair of intermediate plates 130 is disposed between the first clutch 68 and the first clutch plate 72 and one of the pair of intermediate plates 130 is disposed between the second clutch 70 and the second clutch plate 74. In such aspects, the pair of intermediate plates 130 may be fixedly or pressingly coupled to the pair of clutches 68, 70, respectively, and positioned on the first side 78 of the wheel gear 44 and the second side 80 of the wheel gear 44, respectively. Each of the intermediate plates 130 axially receives the output shaft 82 and is configured to rotate about the output axis 22. Furthermore, each of the intermediate plates 130 may be coupled to one of the first clutch plate 72 and the second clutch plate 74 so as to rotate about the output axis 22 with the same angular velocity as at least one of the first clutch plate 72 and the second clutch plate 74.

Referring to FIGS. 5-7, the housing 14 of the rotary actuator 10 is configured to receive port liners 132 within the ports 92 of the housing 14. As illustrated, the housing 14 defines two ports 92, each port 92 receiving two port liners 132 on opposing sides of the rotation plane 76 of the wheel gear 44. Accordingly, four port liners 132 are disposed in the housing 14. Each port liner 132 includes one insertion end 134 disposed within one of the ports 92 and one flanged end 136 that restrains the depth at which the port liner 132 may be inserted into one of the ports 92 of the housing 14. Each housing half 32 includes two port liners 132. It is contemplated that the number and/or the dimensions of the ports 92 and the port liners 132 may vary between constructions. For example, the rotary actuator 10 may include no port liners 132 and/or a single port 92.

Referring now to FIGS. 7-9, the housing 14 includes the control compartment 116, the side cavities 96, and a primary cavity 138 configured to house the worm gear assembly 38. The control compartment 116 is configured to sealably couple to an external surface. The primary cavity 138 is configured to sealably couple to the clutch plates 72, 74. The pair of side cavities 96 are configured to sealably couple to the pair of side plates 94, respectively. In some instances, the housing 14 may also include auxiliary cavities in various locations about the housing 14 for accessing mounted switches, wiring, and/or mounting hardware. Auxiliary covers can further be respectively sealably coupled to the auxiliary cavities, creating a sealed connection with an ingress protection rating of at least IP66. A sealant may be used for the sealed connection between an auxiliary cavity and an auxiliary cover to achieve at least an IP66 ingress protection rating. Each of the control compartment 116, the side cavities 96, primary cavity 138, and auxiliary cavities may define through ports therein to enable the passage of electronic wiring and other components through the housing 14.

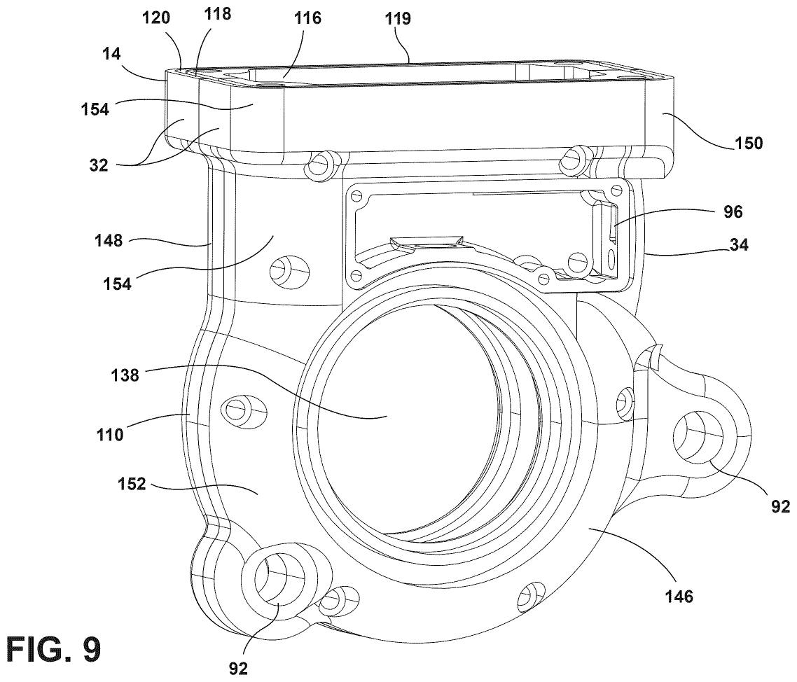

The housing 14 has a contour designed to limit pinch points and prevent access to open gear faces. The housing 14, illustrated in FIG. 9, defines a head 146, a neck 148, and a base 150. As illustrated, the head 146 of the housing 14 is substantially cylindrical in shape and includes filleted edges 152. The neck 148 of the housing 14 extends from the head 146 and has a cross-section that is primarily rectangular in shape, having filleted corners 154. The base 150 of the housing 14 extends from the neck 148 opposite the head 146 and has a primarily rectangular cross-section that is larger than the cross-section of the neck 148, the base 150 also having filleted corners 154. The housing 14, along with other components of the rotary actuator 10, may be made of material including but not limited to stainless steel. It is contemplated that the housing 14 may have a wide variety of geometries. According to one example, the cross-section of the base 150 of the housing 14 may be equal to or smaller than the cross-section of the neck 148 of the housing 14. According to another example, the cross-section of the base 150 and/or the cross-section of the neck 148 may be substantially cylindrical in shape.

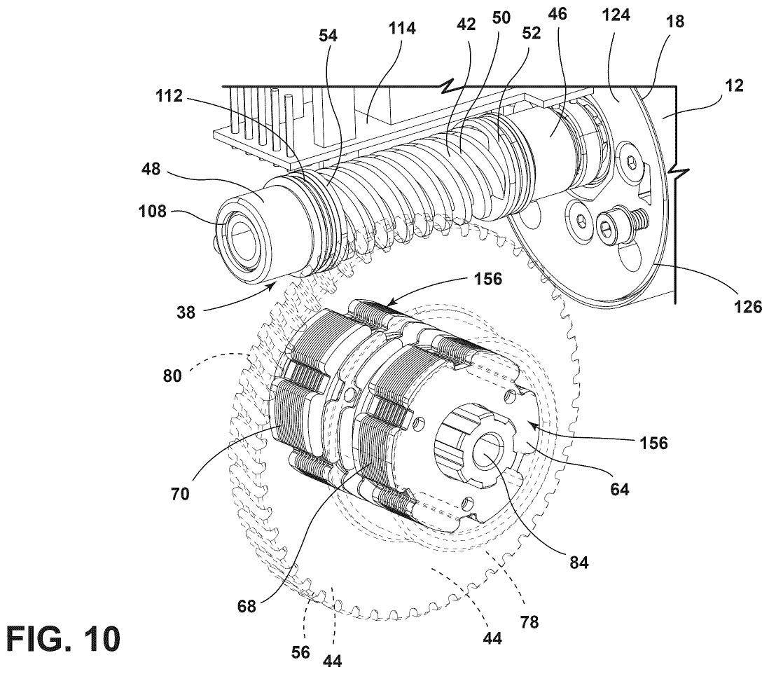

Referring to FIGS. 4 and 10, a combination of one of the pair of clutches 68, 70 and one of the Belleville washers 85 forms a clutch assembly 156. The clutch assembly 156 relies at least partially on a force generated by one of the Belleville washers 85, which are in contact with the wheel gear 44, to drive rotation of one of the clutch plates 72, 74. Each of the pair of clutches 68, 70 may be a torque limiting clutch in some instances, such as those where an undesired amount of force and/or torque may be applied to the rotary actuator 10. The pair of clutches 68, 70 may further be made of a variety of materials, including but not limited to steel, such as stainless steel, titanium, brass, or aluminum. Furthermore, the pair of clutches 68, 70 may be laser-cut or stamped sheet metal and may have a variety of friction coefficients and mechanical properties. The Belleville washers 85 may be substituted with alternative springs, and the number of Belleville washers 85 in the clutch assembly 156 may vary. Each of the Belleville washers 85 may also be a series of internally splined, hex, or pinned discs positioned between one of the pair of clutches 68, 70 and the wheel gear 44.

Referring now to FIG. 11, the illustrated equations describe the relationship between the angular velocity and the torque output of the worm gear 42 of the rotary actuator 10, given that the worm gear assembly 38 is a one-start assembly and that the gearmotor 40 has a 50:1 gear ratio. The torque output of the rotary actuator 10 may further depend on a variety of other variables, notable variables including gear efficiency of the worm gear assembly 38 and whether the worm gear assembly 38 is polished or not polished.

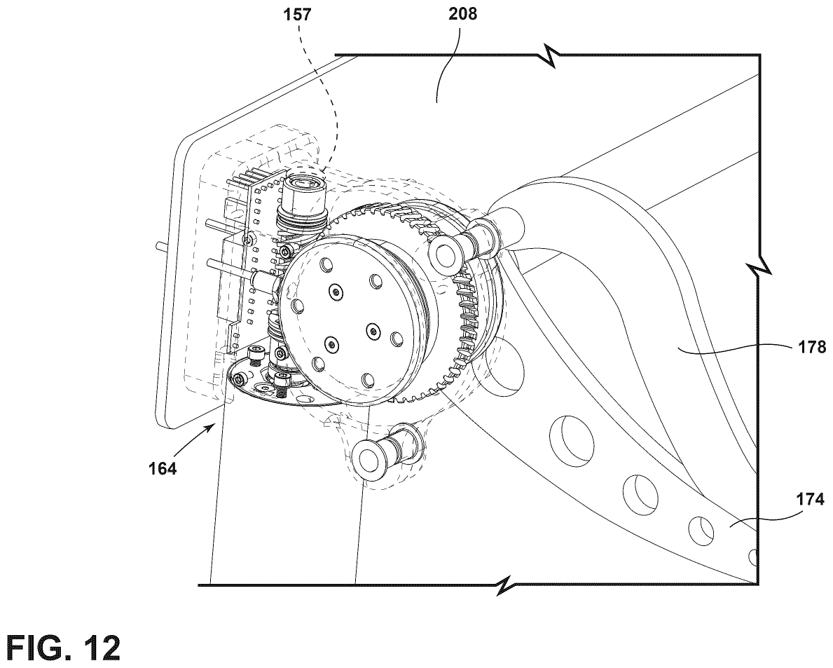

Referring now to FIG. 12, the housing 14 of the rotary actuator 10 also defines a manual drive port 157 exposing the outer flanged bearing 48, the worm gear 42, and/or another component coupled to the worm gear 42, where the outer flanged bearing 48, the worm gear 42, and/or another component coupled to the worm gear 42 is configured to receive an adjustment device. A user may manipulate the outer flanged bearing 48, the worm gear 42, and/or another component coupled to the worm gear 42 with the adjustment device and cause rotation of one or more clutch plates 16 provided by the rotary actuator 10 via rotation of the drive train 35 without actuation of the rotary actuator 10, thereby providing a manual override.

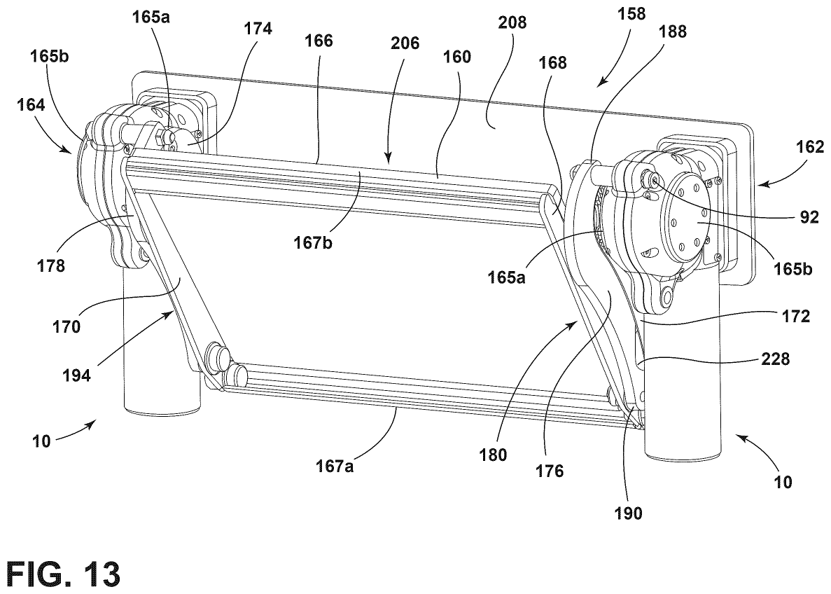

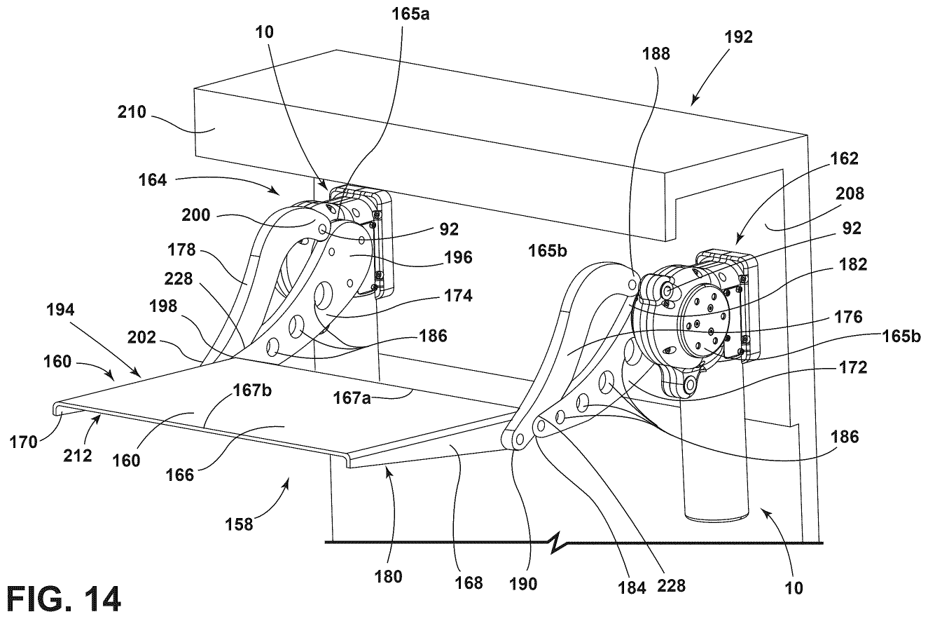

With reference to FIGS. 13 and 14, one or more of the rotary actuator 10 may be incorporated within an articulating step arrangement 158. As illustrated, the articulating step arrangement 158 is a twin actuator articulating step arrangement that includes a movable step 160 and the one or more actuators 10, the one or more actuators 10 including a first rotary actuator 162 and a second rotary actuator 164. Furthermore, each of the first rotary actuator 162 and the second rotary actuator 164 includes one or more clutch plates 16. As illustrated, the one or more clutch plates 16 of each of the first rotary actuator 162 and the second rotary actuator 164 include an inner clutch plate 165a and an outer clutch plate 165b. The movable step 160 defines a step surface 166 extending between an inner side 167a and an outer side 167b. The movable step 160 is supported by a first support member 168 and a second support member 170.

The movable step 160 is rotatably coupled to the first and second rotary actuators 162, 164 with a pair of arms 172, 174 and a pair of links 176, 178. The pair of arms 172, 174 includes a first arm 172 and a second arm 174, and the pair of links 176, 178 includes a first link 176 and a second link 178. On a first side 180 of the movable step 160, a first end 182 of the first arm 172 is coupled to the inner clutch plate 165a of the first rotary actuator 162, and a second end 184 of the first arm 172 is pivotally coupled to the first support member 168. As illustrated, the pair of arms 172, 174 are arcuate in shape, have substantially equal lengths, and define a plurality of through holes 186. Furthermore, a first end 188 of the first link 176 is pivotally coupled to one of the ports 92 of the first rotary actuator 162, and a second end 190 of the first link 176 is pivotally coupled to the first support member 168. The pair of links 176, 178 are also arcuate in shape and are positioned above the arms 172, 174 with respect to a marine vehicle 192 when the movable step 160 is in an extended position 212, as discussed further below. On a second side 194 of the movable step 160, a first end 196 of the second arm 174 is coupled to the inner clutch plate 165a of the second rotary actuator 164, and a second end 198 of the second arm 174 is pivotally coupled to the second member 170 of the movable step 160. Furthermore, a first end 200 of the second link 178 is pivotally coupled to one of the ports 92 of the second rotary actuator 164, and a second end 202 of the second link 178 is pivotally coupled to the second member 170.

Many components of the articulating step arrangement 158, such as the movable step 160, the support members 168, 170, the pair of arms 172, 174, the pair of links 176, 178, and/or other components, may be laser cut tubing and may be made from a durable material such as aluminum, stainless steel, or carbon fiber. In some configurations, the articulating step arrangement 158 may include additional movable steps 160, support rails, and/or handrails. The articulating step arrangement 158 may also include components such as teak/EVA/Acrylic/carbon treads and stab-in handrails.

Referring still to FIGS. 13 and 14, the first and second rotary actuators 162, 164 are provided to simultaneously drive the movable step 160, and the control board 114 of each of the first and second rotary actuators 162, 164 is in communication with the other of the first and second rotary actuators 162, 164, a stand-alone control area network (CAN) controller and/or a multi-function display. As with other applications, the control board 114 and/or a control module may enable digital current control of torque output of the first and second rotary actuators 162, 164. In some instances, the first rotary actuator 162 and the second rotary actuator 164 do not respectively house the control boards 114 and instead are controlled by a switch such as a rocker switch. The described control of the first rotary actuator 162 and the second rotary actuator 164 of the articulating step arrangement 158 in the twin actuator articulating step arrangement may be similar to the control of one or more of the rotary actuator 10 in other arrangements, such as a single actuator articulating step arrangement, a twin actuator articulating rod rack arrangement, and a single actuator articulating rod rack arrangement.

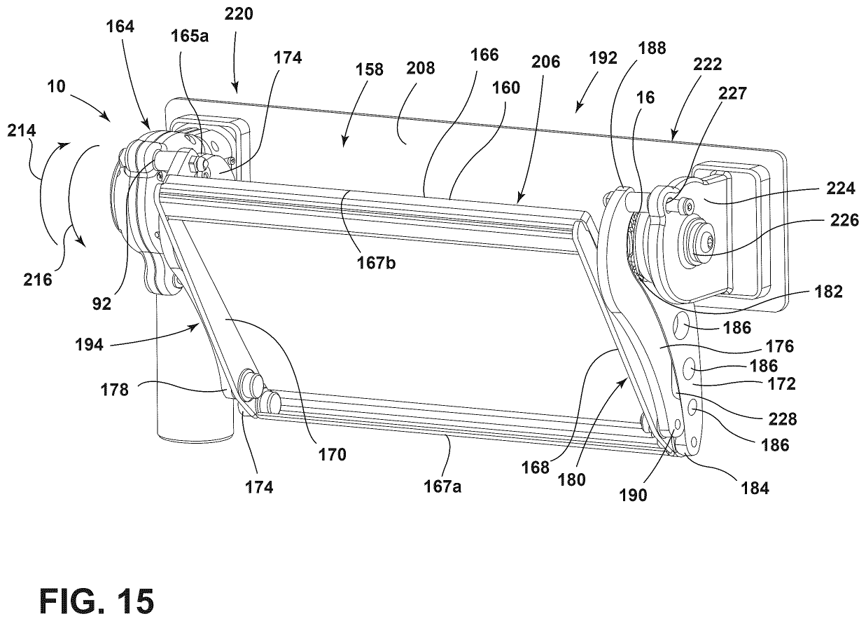

The movable step 160 is operable between a retracted position 206 (FIG. 13) and an extended position 212 (FIG. 12). The first and second rotary actuators 162, 164 are secured to a marine surface 208 under a gunwale 210 of the vehicle 192, where the first and second rotary actuators 162, 164 are in a spaced relationship with each other. When the movable step 160 is in the retracted position 206 and the inner clutch plates 165a of the first and second rotary actuators 162, 164 are rotated in a first direction 214 (FIG. 15), the pair of arms 172, 174 and the pair of links 176, 178 pivot the movable step 160 from the retracted position 206 toward the extended position 212. When the movable step 160 is in the extended position 212, the inner side 167a of the step surface 166 is situated proximate the marine surface 208, and the outer side 167b of the step surface 166 is situated outward from the marine surface 208 relative to the inner side 167a. The movable step 160 may also then be pivoted from the extended position 212 toward the retracted position 206 in response to rotation of the inner clutch plates 165a of the first and second rotary actuators 162, 164 in a second direction 216 (FIG. 15). When the movable step 160 is in the retracted position 206, the step surface 166 substantially faces the marine surface 208.

With further reference to FIGS. 13 and 14, the first ends 188, 200 of the pair of links 176, 178 are situated above the second ends 190, 202 of the pair of links 176, 178 in the retracted position 206. Similarly, the first ends 182, 196 of the pair of arms 172, 174 are situated above the second ends 184, 198 of the pair of arms 172, 174 in the retracted position 206. Furthermore, when the movable step 160 is in the extended position 212, the second end 190 of the first link 176 is further from the output axes 22 of the first and second rotary actuators 162, 164 than the second end 184 of the first arm 172. When the movable step 160 is in the retracted position 206, the second end 190 of the first link 176 is situated closer to the output axes 22 of the first and second rotary actuators 162, 164 than the second end 184 of the first arm 172. Similarly, when the movable step 160 is in the extended position 212, the second end 202 of the second link 178 is further from the output axes 22 of the first and second rotary actuators 162, 164 than the second end 198 of the second arm 174. When the movable step 160 is in the retracted position 206, the second end 202 of the second link 178 is situated closer to the output axes 22 of the first and second rotary actuators 162, 164 than the second end 198 of the second arm 174. This configuration enables the movable step 160 to rotate with respect to the vehicle 192 upon rotation of the inner clutch plates 165a of the first and second rotary actuators 162, 164, where the movable step 160 rotates in a direction opposite the direction of rotation of the inner clutch plates 165a of the first and second rotary actuators 162, 164.

Referring to FIG. 15, the rotary actuator 10 is utilized in the single actuator articulating step arrangement of the articulating step arrangement 158. As illustrated, the articulating step arrangement 158 includes the second rotary actuator 164 and not the first rotary actuator 162. The second rotary actuator 164 is secured to the marine surface 208 of the vehicle 192. On a drive side 220 of the movable step 160, which is illustrated as the second side 194 of the movable step 160, the first end 196 of the second arm 174 is coupled to the inner clutch plate 165a of the second rotary actuator 164, and the second end 198 of the second arm 174 is pivotally coupled to the second support member 170. The first end 200 of the second link 178 is pivotally coupled to one of the ports 92 of the second rotary actuator 164, and the second end 202 of the second link 178 is pivotally coupled to the second support member 170 at a connection location further from the inner side 167a of the step surface 166 than the second end 198 of the second arm 174. This configuration of the second link 178 and the second arm 174 pivots the movable step 160 between the retracted position 206 of the movable step 160 and the extended position 212 of the movable step 160 in response to rotation of the clutch plate 16 of the second rotary actuator 164.

The movable step 160 also includes a driven side 222, which is illustrated as the first side 180 of the movable step 160 in FIG. 15. A support bracket 224 and a bearing 226 are provided at the driven side 222 of the movable step 160, the support bracket 224 securing to the marine surface 208 and the bearing 226 disposed on the support bracket 224. The driven side 222 of the movable step 160 is pivotally coupled to the support bracket 224 via the bearing 226 and therefore is pivotally coupled to the marine surface 208. The driven side 222 of the movable step 160 includes the first link 176 and the first arm 172 to assist with operating the movable step 160 between the extended position 212 and the retracted position 206. The first end 182 of the first arm 172 is pivotally coupled to the support bracket 224 via the bearing 226, while the second end 184 of the first arm 172 is pivotally coupled to the movable step 160. The first end 188 of the first link 176 is pivotally coupled to a bracket port 227 defined by the support bracket 224, where the bracket port 227 is spaced from the bearing 226, and the second end 190 of the first link 176 is pivotally coupled to the movable step 160.

With reference to FIGS. 13-15, each of the pair of links 176, 178 includes a notch 228 configured to receive one of the pair of arms 172, 174. The notch 228 of the first link 176 is configured to receive the second end 184 of the first arm 172 when the movable step 160 is in the extended position 212, and the notch 228 of the second link 178 is configured to receive the second end 198 of the second arm 174 when the movable step 160 is in the extended position 212. The notch 228 acts as a mechanical stop to prevent the movable step 160 from extending past a desired position, which may be the extended position 212, and/or to prevent the clutch plates 16 of the one or more rotary actuators 10 of the articulating step arrangement 158 from rotating past a desired rotational angle.

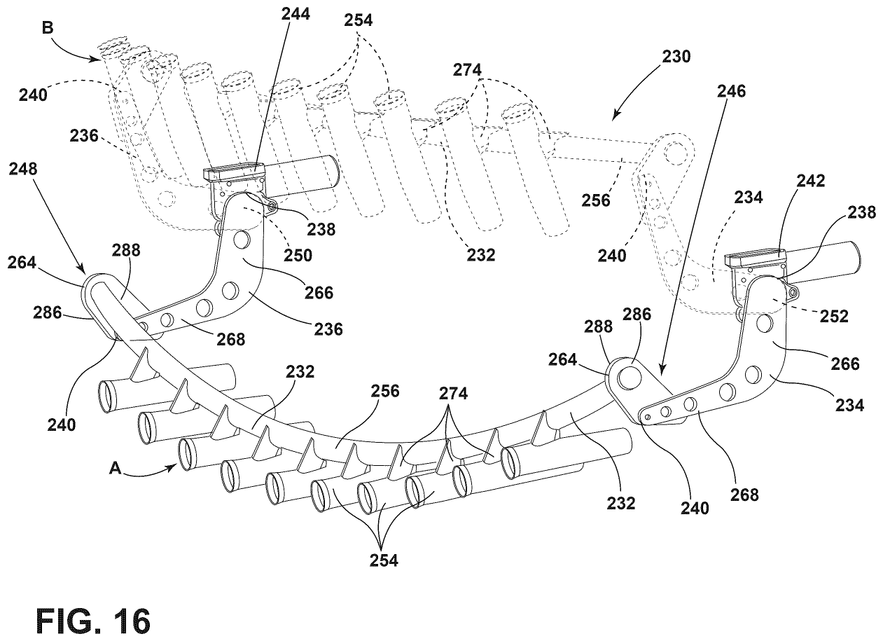

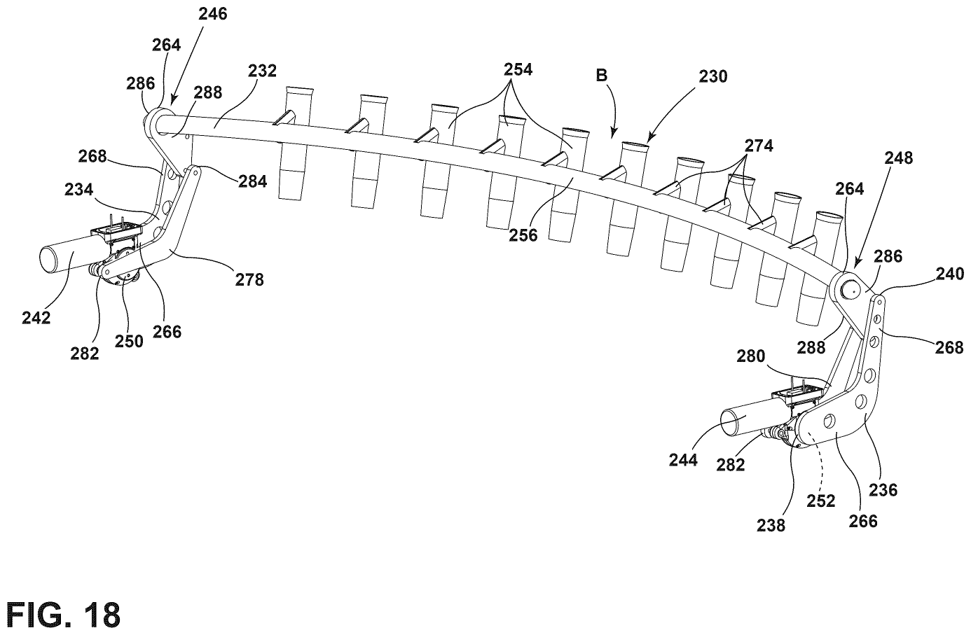

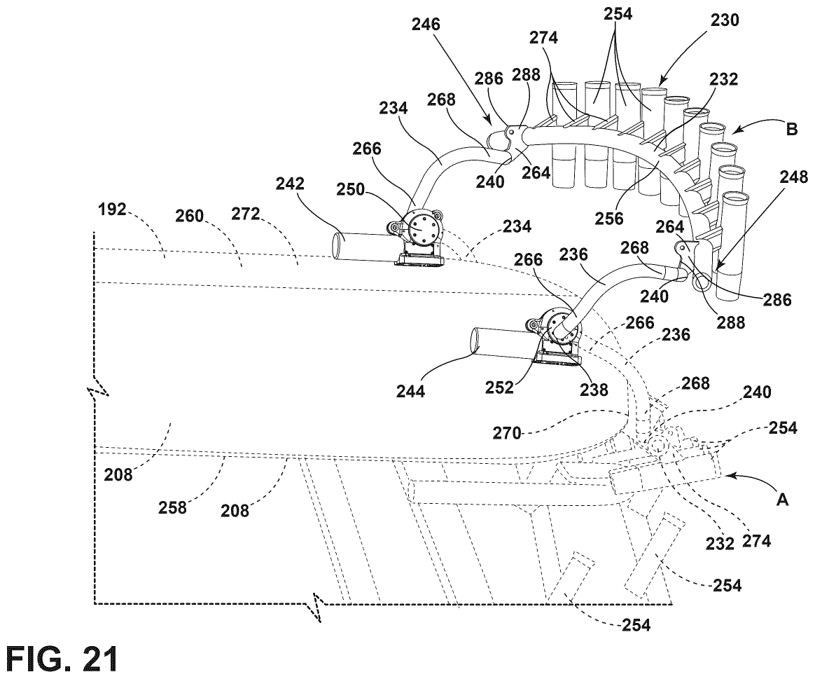

Referring now to FIG. 16, a pair of rotary actuators 10 (FIG. 1) are incorporated into the articulating rod rack arrangement 230 to form the twin actuator articulating rod rack arrangement. As illustrated, the articulating rod rack arrangement 230 includes a crossbar 232 extending between a first arm 234 and a second arm 236, each of the first arm 234 and the second arm 236 having a first end 238 and a second end 240. The pair of rotary actuators 10 include a first rotary actuator 242 and a second rotary actuator 244, where the first rotary actuator 242 is disposed proximate a first side 246 of the articulating rod rack arrangement 230 and the second rotary actuator 244 is disposed proximate a second side 248 of the articulating rod rack arrangement 230. Each of the first rotary actuator 242 and the second rotary actuator 244 is configured to be coupled to the marine surface 208 (FIG. 21) and includes an inner clutch plate 250 and an outer clutch plate 252 (FIGS. 16 and 18). The first end 238 of the first arm 234 is coupled to the outer clutch plate 252 of the first rotary actuator 242, and the first end 238 of the second arm 236 is coupled to the inner clutch plate 250 of the second rotary actuator 244. A plurality of rod receptacles 254 (hereinafter “rod holders”) are coupled to and spaced along the crossbar 232 between the first side 246 and the second side 248. Together, the crossbar 232 and the plurality of rod holders 254 form a rod rack 256.

The articulating rod rack arrangement 230 is configured to rotate the rod rack 256 between one or more positions. As illustrated, the one or more positions into which the rod rack 256 is rotatable include a fully lowered position A and a fully raised position B. Additionally, the rod rack 256 may be rotatable into one or more intermediate positions between the fully lowered position A and the fully raised position B. In some configurations, the articulating rod rack arrangement 230 may only include one of the first rotary actuator 242 and the second rotary actuator 244 so as to form the single actuator articulating rod rack arrangement. In such configurations, one of the first arm 234 and the second arm 236 may be coupled to a support bracket similar to the support bracket 224 of the articulating step arrangement 158 configured as the single actuator articulating step arrangement.

As illustrated in FIG. 16, the first rotary actuator 242 and the second rotary actuator 244 are laterally spaced from each other and have a uniform angular orientation. Each of the first rotary actuator 242 and the second rotary actuator 244 is configured to couple to the marine surface 208 and, specifically, a downward-facing surface 258 of a top panel 260 of the marine vehicle 192 (FIG. 21). The top panel 260 may be a hard top structure, such as a T-top, a hard Bimini top, a cabin roof, a pilot house cover, and/or a fly-bridge panel, for example. Alternatively, each of the first rotary actuator 242 and the second rotary actuator 244 may be coupled to another marine surface 208 or a marine feature, such as a tower structure, the gunwale 210, a leaning post, or a coffin box. According to some aspects, the first rotary actuator 242 may have an angular orientation that is offset relative to the second rotary actuator 244. The inner and outer clutch plates 250, 252 (FIGS. 16 and 18) of each of the first rotary actuator 242 and the second actuator 244 may be infinitely rotatable relative to the marine surface 208. Accordingly, the rod rack 256 may be configured to have virtually any rotational range. For example, the rod rack 256 may have a rotational range relative to the marine surface 208 between 30 degrees and 270 degrees. According to this example, the fully lowered position A may be angularly offset relative to the fully raised position B by a magnitude between 30 degrees and 270 degrees. It is also contemplated that the first rotary actuator 242 and/or the second rotary actuator 244 may include only one of the inner and outer clutch plates 250, 252.

The crossbar 232 of the articulating rod rack arrangement 230 may have a wide variety of geometries according to the present disclosure. As illustrated in FIG. 16, the crossbar 232 has a tubular shape and extends arcuately between the first and second sides 246, 248 of the articulating rod rack arrangement 230. According to some aspects, a cross-sectional geometry of the crossbar 232 may be circular, elliptical, squared, or alternatively shaped. Additionally or alternatively, the crossbar 232 may extend substantially straight between the first side 246 and the second side 248. It is also contemplated that the number of rod holders 254 coupled to the crossbar 232 may vary between configurations of the articulating rod rack arrangement 230. According to one example, a single rod holder 254 may be coupled to the crossbar 232. As illustrated in FIG. 16, 10 rod holders 254 are coupled to the crossbar 232. In some instances, the crossbar 232 may support one or more other components in addition to or instead of the plurality of rod holders 254, such as a navigation light, for example.

With reference to FIGS. 16 and 18, the first ends 238 of the first arm 234 and the second arm 236 are respectively coupled to the outer clutch plate 252 of the first rotary actuator 242 and the inner clutch plate 250 of the second rotary actuator 244. Consequently, the first arm 234 and the second arm 236 rotate relative to the marine surface 208 with the outer clutch plate 252 of the first actuator 242 and the inner clutch plate 250 of the second rotary actuator 244, respectively. According to some aspects, the first end 238 of the first arm 234 may be coupled to the inner clutch plate 250 of the first rotary actuator 242. Additionally or alternatively, the first end 238 of the second arm 236 may be coupled to the outer clutch plate 252 of the second rotary actuator 244. Furthermore, the first end 238 of the first arm 234 may be coupled to the outer clutch plate 252 of the first rotary actuator 242 via fasteners respectively fastened to the attachment points 28 of said outer clutch plate 252. In instances where the first arm 234 is coupled to the inner clutch plate 250 of the first rotary actuator 242, the first end 238 of the first arm 234 may be coupled to said inner clutch plate 250 via fasteners respectively fastened to the attachment points 28 of said inner clutch plate 250. Similarly, the first end 238 of the second arm 236 is coupled to the inner clutch plate 250 of the second rotary actuator 244 via fasteners respectively fastened to the attachment points 28 of said inner clutch plate 250. In instances where the second arm 236 is coupled to the outer clutch plate 252 of the second rotary actuator 244, the first end 238 of the second arm 236 may be coupled to said outer clutch plate 252 via fasteners that are fastened to the attachment points 28 of said outer clutch plate 252. In addition to or instead of the fasteners, each of the first ends 238 of the first arm 234 and the second arm 236 may be coupled to one of the inner and outer clutch plates 250, 252 via an adhesive material, welding, or rivets, for example.

The second ends 240 of the first arm 234 and the second arm 236 are coupled to the crossbar 232 proximate the first and second sides 246, 248 of the articulating rod rack arrangement 230, respectively. Particularly, the second end 240 of each of the first arm 234 and the second arm 236 is coupled to one of a pair of intermediate brackets 264, wherein the crossbar 232 is coupled to the pair of intermediate brackets 264 proximate the first side 246 and the second side 248, respectively. As illustrated in FIGS. 16 and 18, the crossbar 232 extends through one of the pair of intermediate brackets 264 at the first side 246 and through one of the pair of intermediate brackets 264 at the second side 248. Accordingly, each of the first arm 234 and the second arm 236 is indirectly coupled to the crossbar 232. It is contemplated that the crossbar 232 may be fastened to, adhered to, welded to, interlocked with, or otherwise coupled to each of the pair of intermediate brackets 264, and the second ends 240 of the first arm 234 and the second arm 236 may also be respectively fastened to, adhered to, welded to, interlocked with, or otherwise coupled to the pair of intermediate brackets 264. In some instances, the first arm 234 and/or the second arm 236 may be directly coupled to the crossbar 232 such that the articulating rod rack arrangement 230 does not include one or both of the pair of intermediate brackets 264.

Referring still to FIGS. 16 and 18, each of the first arm 234 and the second arm 236 is additionally bent between the first end 238 thereof and the second end 240 thereof. Particularly, each of the first arm 234 and the second arm 236 includes a first segment 266 extending from one of the first rotary actuator 242 and the second rotary actuator 244 and a second segment 268 extending obliquely from the first segment 266, the first segment 266 and the second segment 268 being integrally formed. Accordingly, in an instance where the first rotary actuator 242 and the second rotary actuator 244 are coupled to the downward-facing surface 258 of the top panel 260 (FIG. 21) and the rod rack 256 is in the fully raised position B, the first segments 266 of the first arm 234 and the second arm 236 are configured to extend along the downward-facing surface 258 and the second segments 268 of the first arm 234 and the second arm 236 are configured to extend upward across a rear edge 270 (FIG. 21) of the top panel 260 and upward relative to an upward-facing surface 272 (FIG. 21) of the top panel 260. In some instances, the first segment 266 of each of the first arm 234 and the second arm 236 and the second segment 268 of each of the first arm 234 and the second arm 236 may be separately formed and coupled to each other. With regard to each of the first arm 234 and the second arm 236, it is contemplated that the second segment 268 may extend orthogonally from or parallel to the first segment 266 in some configurations.

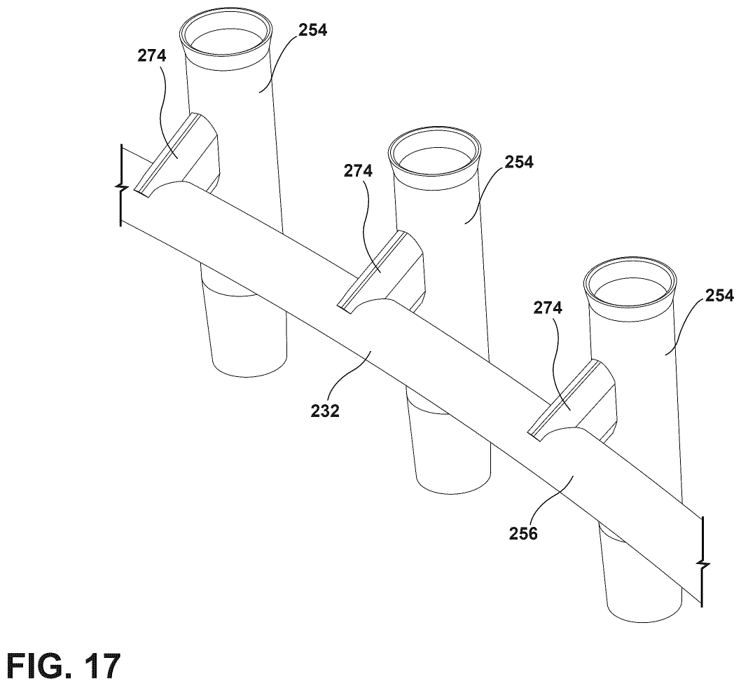

With reference to FIGS. 16 and 17, the crossbar 232 supports the plurality of rod holders 254 such that the plurality of rod holders 254 are rotatably and linearly displaced when the rod rack 256 is rotated between the fully lowered position A and the fully raised position B. As illustrated, a plurality of projections 274 are coupled to and extend from the crossbar 232, the plurality of projections 274 being evenly spaced along the crossbar 232 between the first side 246 and the second side 248 of the articulating rod rack arrangement 230. The plurality of projections 274 are coupled to the plurality of rod holders 254, respectively, such that the plurality of rod holders 254 are uniformly spaced from the crossbar 232 and have a uniform orientation relative to each other. Each of the plurality of rod holders 254 is configured to retain an item such as a fishing rod, an elongate boat hook, an outrigger, and/or another marine feature, for example. According to some aspects, one or more of the plurality of rod holders 254 may be directly coupled to the crossbar 232 such that the rod rack 256 does not include one or more of the plurality of projections 274. Additionally or alternatively, one or more of the plurality of rod holders 254 may have an angular orientation that is offset relative to another one of the plurality of rod holders 254. In some instances, the plurality of rod holders 254 may be non-uniformly spaced from the crossbar 232. It is also contemplated that one or more additional rod holders 254 may be coupled to the first arm 234 and/or the second arm 236, among one or more other marine components. It is also contemplated that each of the plurality of rod holders 254 may have a wide variety of geometries, including but not limited to a cylindrical geometry or a squared geometry.

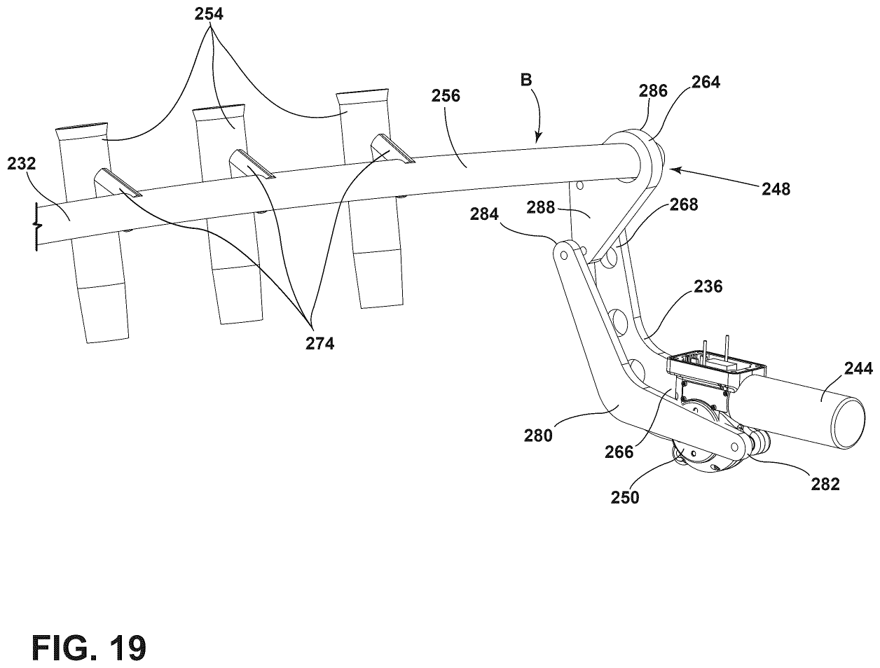

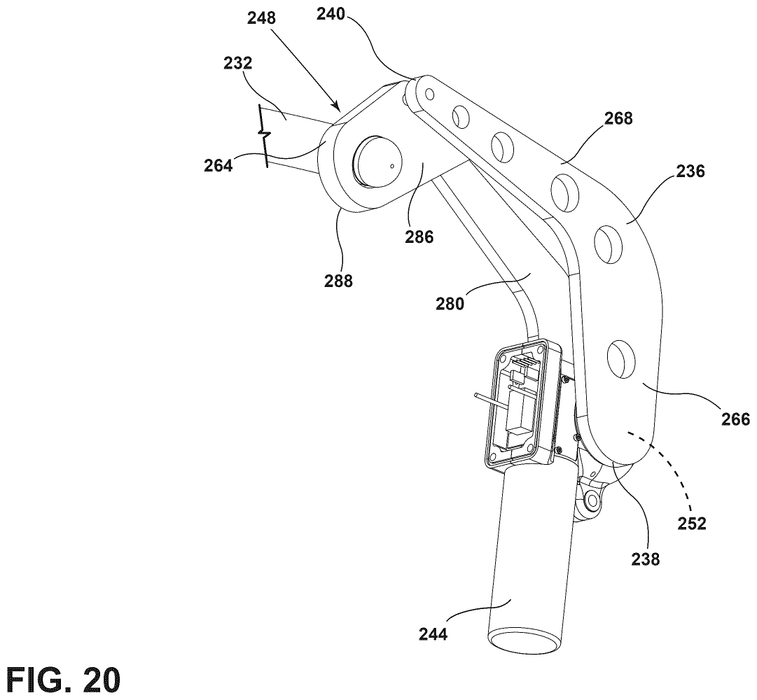

With reference to FIGS. 18-22, the articulating rod rack arrangement 230 may also include a third arm 278 and a fourth arm 280, each of the third arm 278 and the fourth arm 280 extending between a first end 282 and a second end 284. As illustrated, the first end 238 of the first arm 234 is coupled to the outer clutch plate 252 of the first rotary actuator 242, and the first end 238 of the second arm 236 is coupled to the outer clutch plate 252 of the second rotary actuator 244. Furthermore, the second end 240 of the first arm 234 is coupled to an outer surface 286 of one of the pair of intermediate brackets 264 proximate the first side 246 of the articulating rod rack arrangement 230, and the second end 240 of the second arm 236 is coupled to the outer surface 286 of one of the pair of intermediate brackets 264 proximate the second side 248 of the articulating rod rack arrangement 230. The first end 282 of the third arm 278 is pivotally coupled to one of the ports 92 of the housing 14 (FIG. 1) of the first rotary actuator 242 and may extend over the inner clutch plate 250 of the first rotary actuator 242 in one or more angular positions of the rod rack 256. The first end 282 of the fourth arm 280 is pivotally coupled to one of the ports 92 of the second rotary actuator 244 and may extend over the inner clutch plate 250 of the second rotary actuator 244 in one or more angular positions of the rod rack 256. The second end 284 of the third arm 278 is coupled to an inner surface 288 of one of the intermediate brackets 264 proximate the first side 246 of the articulating rod rack arrangement 230, thereby forming a four-bar linkage with one of the pair of intermediate brackets 264, the first arm 234, and the first rotary actuator 242. The second end 284 of the fourth arm 280 is coupled to the inner surface 288 of one of the pair of intermediate brackets 264 proximate the second side 248 of the articulating rod rack arrangement 230, thereby forming a four-bar linkage with one of the pair of intermediate brackets 264, the second arm 236, and the second rotary actuator 244. The third arm 278 and the fourth arm 280 may be similarly configured relative to the first arm 234 and the second arm 236, respectively. It is also contemplated that the second ends 240, 284 of the first arm 234 and the third arm 278 may each be coupled to the outer or inner surface 286, 288 of one of the pair of intermediate brackets 264 proximate the first side 246. Additionally or alternatively, the second ends 240, 284 of the second arm 236 and the fourth arm 280 may each be coupled to the outer or inner surface 286, 288 of one of the pair of intermediate brackets 264 proximate the second side 248.

In some instances, each of the first arm 234, the second arm 236, the third arm 278, and the fourth arm 280 may be pivotally coupled to one of the intermediate brackets 264. In one exemplary instance, the second end 240 of the first arm 234 and the second end 284 of the third arm 278 are pivotally coupled to one of the intermediate brackets 264 proximate the first side 246, and the second end 240 of the second arm 236 and the second end 284 of the fourth arm 280 are pivotally coupled to one of the intermediate brackets 264 proximate the second side 248. Here, the second end 240 of the first arm 234 may be radially offset from the second end 284 of the third arm 278, while the second end 240 of the second arm 236 may be radially offset from the second end 284 of the fourth arm 280. Resulting from these radial offsets, the rod rack 256 pivots relative to the first arm 234, the second arm 236, the third arm 278, and the fourth arm 280 when the rod rack 256 is rotated between the fully lowered position A and the fully raised position B such that a change in angular orientation of the rod rack 256 is less than a change in angular orientation of the first arm 234, the second arm 236, the third arm 278, and the fourth arm 280 when the rod rack 256 is rotated between the fully lowered position A and the fully raised position B. In some instances, the plurality of rod holders 254 of the rod rack 256 substantially remain in an upward angular orientation when the rod rack 256 is rotated between the fully lowered position A and the fully raised position B.

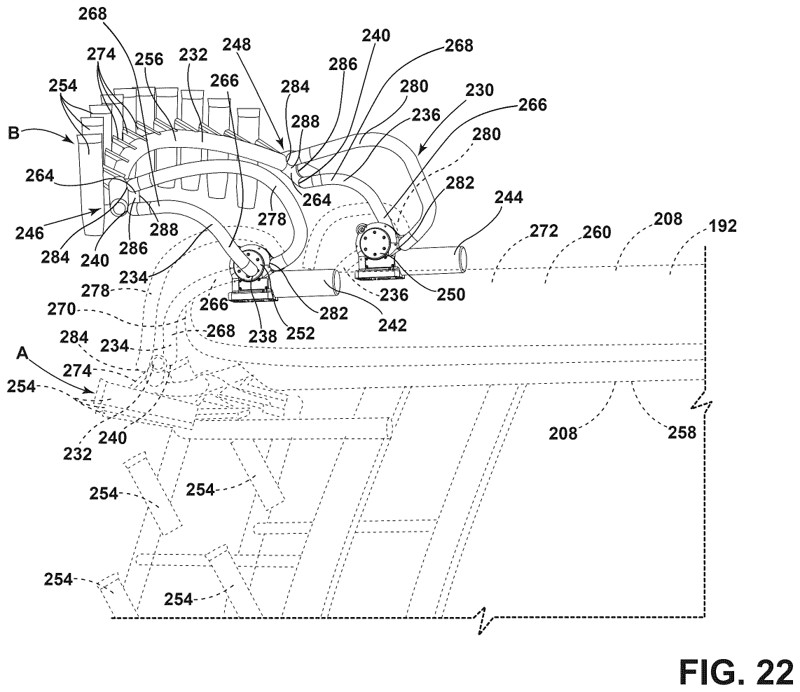

With reference to FIGS. 21 and 22, the first rotary actuator 242 and the second rotary actuator 244 are coupled to the upward-facing surface 272 of the top panel 260 of the marine vehicle 192. As illustrated, the articulating rod rack arrangement 230 includes the first arm 234 and the second arm 236. The first end 238 of the first arm 234 is coupled to the outer clutch plate 252 of the first rotary actuator 242, and the second end 240 of the first arm 234 is coupled to one of the pair of intermediate brackets 264 proximate the first side 246 of the articulating rod rack arrangement 230. Furthermore, the first end 238 of the second arm 236 is coupled to the outer clutch plate 252 of the second rotary actuator 244, and the second end 240 of the second arm 236 is coupled to one of the pair of intermediate brackets 264 proximate the second side 248 of the articulating rod rack arrangement 230. When the rod rack 256 is in the fully raised position B, the first segments 266 of the first arm 234 and the second arm 236 may extend upward from the upward-facing surface 272 of the top panel 260, while the second segments 268 of the first arm 234 and the second arm 236 extend substantially along the upward-facing surface 272 vehicle rearward relative to the first rotary actuator 242 and the second rotary actuator 244. When the rod rack 256 is in the fully lowered position A, the first segments 266 of the first arm 234 and the second arm 236 extend vehicle rearward relative to the first rotary actuator 242 and the second rotary actuator 244, and the second segments 268 of the first arm 234 and the second arm 236 extend downward across the rear edge 270 of the top panel 260 such that the plurality of rod holders 254 of the rod rack 256 are accessible to a user.

As illustrated in FIG. 22, the first end 282 of the third arm 278 is pivotally coupled to one of the ports 92 of the housing 14 (FIG. 1) of the first rotary actuator 242, and the second end 284 of the third arm 278 is coupled to one of the intermediate brackets 264 proximate the first side 246 of the articulating rod rack arrangement 230. The first end 282 of the fourth arm 280 is pivotally coupled to one of the ports 92 of the housing 14 of the second rotary actuator 244, and the second end 284 of the fourth arm 280 is coupled to one of the intermediate brackets 264 proximate the second side 248 of the articulating rod rack arrangement 230. The third arm 278 extends between the first rotary actuator 242 and the rod rack 256 above the first arm 234, while the fourth arm 280 extends between the second rotary actuator 244 and the rod rack 256 above the second arm 236. As illustrated in FIGS. 21 and 22, the first arm 234, the second arm 236, the third arm 278, and the fourth arm 280 have a tubular geometry. Notably, the articulating rod rack arrangement 230 may include additional bars extending between the first rotary actuator 242 and one of the pair of intermediate brackets 264 or between the second rotary actuator 244 and one of the pair of intermediate brackets 264.

It is contemplated that each of the components of the articulating rod rack arrangement 230 may be made of a wide variety of materials. According to one nonlimiting exemplary aspect, one or more of the crossbar 232, the first arm 234, the second arm 236, the plurality of rod holders 254, the pair of intermediate brackets 264, the plurality of projections 274, the third arm 278, and/or the fourth arm 280, among other components, may be made of aluminum, carbon fiber, stainless steel, or a polymer material such as plastic.

The rotary actuator 10 and the various arrangements shown and described herein feature a compact, efficient, and streamlined construction that is configured to withstand wet environments. For example, the one or more rotary actuators 10 provided in a given arrangement, such as the articulating step arrangement 158 or the rod rack arrangement 230, may have an ingress protection (IP) rating of IP66, IP67, or IP68. Features of the drive train 35 of the rotary actuator 10, including the worm gear assembly 38, provide variability in torque and speed of the rotary actuator(s) 10 at the one or more clutch plate(s) 16 thereof. Wireless and/or wired electrical connection abilities make the one or more rotary actuators 10 and the arrangements shown and described herein versatile across applications and convenient to use.

In the foregoing description, it will be readily appreciated by those skilled in the art that modifications may be made to the embodiments as disclosed herein without departing from the concepts as disclosed herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure, as shown in the exemplary embodiments, are illustrative only. Although only a few embodiments of the present innovations have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. An articulating rod rack arrangement for a marine vehicle, comprising:
a first rotary actuator configured to be coupled to a marine surface, the first rotary actuator including:
a housing;
a motor disposed within the housing and having a motor shaft;
a worm gear assembly operably coupled to the motor shaft; and
an output plate operably coupled to the worm gear assembly and rotatably coupled to the housing;
a first arm having a first end and a second end, wherein the first end is coupled to the output plate; and
a crossbar coupled to the second end of the first arm such that the crossbar is spaced from the first rotary actuator, the crossbar supporting one or more rod holders, wherein the first rotary actuator is configured to rotate the first arm and the crossbar such that the crossbar is rotatable relative to the housing of the first rotary actuator.

2. The articulating rod rack arrangement of claim 1, further comprising:
a second rotary actuator configured to be coupled to the marine surface, the second rotary actuator including:
a housing;
a motor disposed within the housing of the second rotary actuator and having a motor shaft;
a worm gear assembly operably coupled to the motor shaft of the second rotary actuator;
an output plate operably coupled to the worm gear assembly of the second rotary actuator and rotatably coupled to the housing of the second rotary actuator; and
a second arm having a first end coupled to the output plate of the second rotary actuator and a second end coupled to the crossbar.

3. The articulating rod rack arrangement of claim 2, wherein the crossbar extends between the first rotary actuator and the second rotary actuator such that the first rotary actuator is substantially aligned with a first side of the crossbar and the second rotary actuator is substantially aligned with a second side of the crossbar.

4. The articulating rod rack arrangement of claim 2, wherein the marine surface is a surface of a hard Bimini top panel of a marine vehicle, and wherein the first rotary actuator is coupled to the marine surface.

5. The articulating rod rack arrangement of claim 2, wherein the output plates of the first rotary actuator and the second rotary actuator rotate about a substantially common axis.

6. The articulating rod rack arrangement of claim 1, wherein the output plate of the first rotary actuator rotates about an output axis and the motor shaft of the first rotary actuator rotates about an input axis, and wherein the output axis is orthogonal to the input axis.

7. The articulating rod rack arrangement of claim 6, wherein the output axis is linearly offset from the input axis.

8. The articulating rod rack arrangement of claim 1, wherein the one or more rod holders include a plurality of rod holders.

9. The articulating rod rack arrangement of claim 2, wherein the housing of each of the first rotary actuator and the second rotary actuator defines a control compartment containing a control board.

10. The articulating rod rack arrangement of claim 9, wherein the housing of each of the first rotary actuator and the second rotary actuator includes a peripheral wall surrounding the control compartment thereof and defining an opening to the control compartment thereof, and wherein the peripheral wall is configured to be directly coupled to the marine surface, thereby covering the opening and creating a water-tight seal between the marine surface and the peripheral wall.

11. The articulating rod rack arrangement of claim 1, wherein the crossbar is rotatable relative to the housing of the first rotary actuator between a raised position in which the crossbar is configured to be positioned above the marine surface and a lowered position in which the crossbar is configured to be positioned below the marine surface.

12. An articulating rod rack arrangement, comprising:
a first rotary actuator and a second rotary actuator laterally spaced from the first rotary actuator, each of the first rotary actuator and the second rotary actuator being coupled to a marine surface and including:
a water-tight sealed housing coupled to the marine surface and defining a port;
a motor including a motor shaft configured to rotate about an input axis;
a worm gear assembly operably coupled to the motor shaft; and
an output plate rotatably coupled to the housing, wherein the output plate is configured to rotate about an output axis;
a first arm and a second arm, wherein each of the first arm and the second arm has a first end coupled to one of the output plate of the first rotary actuator and the output plate of the second rotary actuator and a second end extended from one of the first rotary actuator and the second rotary actuator;
a crossbar coupled to the second end of each of the first arm and the second arm and rotatable relative to the marine surface between a raised position and a lowered position, wherein the crossbar is in a spaced relationship with each of the first rotary actuator and the second rotary actuator in the raised position and the lowered position; and
one or more rod holders coupled to the crossbar.

13. The articulating rod rack arrangement of claim 12, further comprising:
a third arm having a first end and a second end, wherein the first end of the third arm is pivotally coupled to the port of the first rotary actuator and the second end of the third arm is coupled to the crossbar; and
a fourth arm having a first end and a second end, wherein the first end of the fourth arm is pivotally coupled to the port of the second rotary actuator and the second end of the fourth arm is coupled to the crossbar.

14. The articulating rod rack arrangement of claim 13, wherein the second ends of the first arm, the second arm, the third arm, and the fourth arm are pivotally coupled to the crossbar such that the crossbar pivots relative to the first arm, the second arm, the third arm, and the fourth arm when the crossbar is rotated between the raised position and the lowered position.

15. The articulating rod rack arrangement of claim 12, wherein the one or more rod holders are positioned above the marine surface in the raised position, and wherein the one or more rod holders are positioned below the marine surface in the lowered position.

16. The articulating rod rack arrangement of claim 12, wherein the first arm and the second arm are disposed between the first rotary actuator and the second rotary actuator.

17. The articulating rod rack arrangement of claim 12, wherein the first rotary actuator and the second rotary actuator are disposed between the first arm and the second arm.

18. An articulating rod rack arrangement for a marine vehicle, comprising:
a first rotary actuator coupled to a marine surface, the first rotary actuator including:
a housing;
a motor including a motor shaft configured to rotate about an input axis;
a worm gear assembly operably coupled to the motor shaft;
a first output plate rotatably coupled to the housing and operably coupled to the worm gear assembly; and
a second output plate rotatably coupled to the housing and operably coupled to the worm gear assembly, wherein the first output plate and the second output plate are rotatable about an output axis; and
a rod rack operably coupled to one of the first output plate and the second output plate, wherein the rod rack is rotatable between a raised position and a lowered position and includes:
a crossbar; and
one or more rod holders coupled to the crossbar.

19. The articulating rod rack arrangement of claim 18, further comprising:
a first arm having a first end coupled to one of the first output plate and the second output plate and a second end coupled to the rod rack, wherein the rod rack is spaced from the first rotary actuator.

20. The articulating rod rack arrangement of claim 19, further comprising:
a second rotary actuator coupled to the marine surface, the second rotary actuator including:
a housing;
a motor including a motor shaft configured to rotate about an input axis;
a worm gear assembly operably coupled to the motor shaft of the second rotary actuator;
a first output plate rotatably coupled to the housing of the second rotary actuator and operably coupled to the worm gear assembly of the second rotary actuator; and
a second output plate rotatably coupled to the housing of the second rotary actuator and operably coupled to the worm gear assembly of the second rotary actuator, wherein the first output plate of the second rotary actuator and the second output plate of the second rotary actuator are rotatable about an output axis, and wherein the rod rack is coupled to one of the first output plate of the second rotary actuator and the second output plate of the second rotary actuator.

21. The articulating rod rack arrangement of claim 20, further comprising:
a second arm having a first end coupled to one of the first output plate of the second rotary actuator and the second output plate of the second rotary actuator and a second end coupled to the rod rack.

22. The articulating rod rack arrangement of claim 18, wherein the rod rack is positioned above the marine surface in the raised position, and wherein the rod rack is positioned below the marine surface in the lowered position.
